(19) United States
(12) Patent Application Publication
(10) Pub. No.: US 2019/0083911 A1
(43) Pub. Date: Mar. 21, 2019

(54) Canister Transmission Filter System

(71) Applicant: John Tianci Li, Roslyn Heights, NY (US)

(72) Inventor: John Tianci Li, Roslyn Heights, NY (US)

(21) Appl. No.: 15/709,422

(22) Filed: Sep. 19, 2017

(51) Int. Cl. B01D 35/00; F16H 57/04; B01D 35/143; B01D 35/30; B01D 35/06

(52) U.S. Cl. CPC B01D 35/005; F16H 57/0404; B01D 35/143; B01D 35/30; B01D 2201/4092; B01D 2201/12; B01D 2201/24; B01D 2201/4046; B01D 35/06

(57) ABSTRACT

A canister based transmission filter system, which may be integrated into transmission reservoirs. The system features a filter in the shape of a cylinder or a polygonal prism, and a corresponding transmission filter receiver. The filter has a pleated filtration surface with an integrated magnet, and is inserted into the receiver without need of additional screws, clips, nor bolts. The receiver closes off transmission fluid flow when filter is being changed to prevent contamination of the surroundings, and opens when the filter is installed to allow for filtration. Filter may be quickly changed using only the L-pin provided, and locks itself in place during installation.

### CROSS-REFERENCE TO RELATED APPLICATIONS

Not Applicable

### BACKGROUND OF THE INVENTION

### Technical Field of the Invention

The present invention relates to a canister based transmission filter system.

### Background and Prior Art

During the operation of the transmission system, particulate residue is created from the wear of system parts and the chemical degradation of transmission fluid. This residue must be prevented from reentering the transmission system, because it causes further wear and damage to the transmission and may lead to system failure. The purpose of a transmission filter is to sieve out residue, which usually collects in the transmission reservoir. The filter is situated inside the transmission fluid reservoir, and is connected to the transmission pump intake. For most vehicles, transmission filters are advised to be changed every 2 years or 30,000 miles. The standard transmission filter consists of a metal or fiber mesh, encased in a roughly rectangular metal shell that is installed inside the transmission reservoir. The standard method of changing the transmission filter involves draining the transmission fluid, removing the transmission reservoir pan, unscrewing the bolts that hold the transmission fluid filter in place, replacing the transmission filter, and then, returning the transmission reservoir pan. The process, usually done by an automobile mechanic, takes approximately half an hour to an hour, costs approximately 100 USD, and requires extensive cleanup.

### SUMMARY OF THE INVENTION

The invention consists of a canister transmission filter system. The system includes a canister-shaped transmission filter, and a receiver that the transmission filter is installed into. The system may be integrated into transmission fluid reservoirs to allow for easy conversion of existing systems. The transmission filter has the geometry of a cylindrical or polygonal (hexagonal, octagonal, etc.) prism, with notches that allows for the filter to fit into the receiver. The filter has a pleated filtration surface to remove particulate contaminants by physical filtration, and a magnet, to remove metal particles from the transmission fluid.

The geometry of the filter and the receiver allows for the removal of the filter to close off the receiver, and for the installation of the filter to open the receiver. When the filter is removed, the closure of the receiver allows for the isolation of the transmission fluid reservoir and the transmission filter pump from the surroundings, thus preventing contamination of the surroundings by leakage, and contamination of the transmission pump by particulate matter. The proposed transmission filter can be changed more cleanly than the prior art standard, and thus requires less clean up.

The transmission filter can be made of a variety of materials, and usage of plastics allow for a significant reduction of price. The transmission filter can be installed by either using the provided metal L-pin, or an adjustable spanner or socket wrench, and requires no additional bolts nor screws, thus reducing the amount of time that is required to change the transmission filter. The efficiency of the system allows the procedure to be done by the car owner, and reduces cost, time required, utilization of resources, and contamination of the surroundings.

### BRIEF DESCRIPTION OF THE DRAWINGS

The appended drawings of the invention are as follows:

FIG. 1 is an isometric exploded view of the transmission filter system, which exhibits the separate components of the system.

FIG. 2 is an orthographic view of the fully assembled transmission filter system with the transmission filter installed, which exhibits the alignment of apertures in the mobile component of the transmission filter receiver and the transmission filter with the hollow shaft of the stationary component of the transmission filter receiver that leads to the transmission fluid pump.

FIG. 3 is an orthographic view of the transmission filter system with the transmission filter installed, which exhibits the alignment of apertures in the mobile component of the transmission filter receiver with apertures in the stationary component of the transmission filter receiver, that exposes the pleated filtration surface of the transmission filter to the transmission fluid reservoir, to allow for filtration.

FIG. 4 is an orthographic view of the transmission filter system, which exhibits the alignment of indicator markings on the transmission filter and the transmission filter receiver that signifies the transmission filter is installed.

FIG. 5 is an isometric view of the transmission filter system, which exhibits the position of the L-pin that is utilized to remove and install the transmission filter when the transmission filter is installed and bolted into place by the aforementioned L-pin.

FIG. 6 is an isometric view of the transmission filter system, which exhibits the freed L-pin along with the holes in the transmission filter and the hole in the stationary component of the transmission filter receiver.

FIG. 7 is an isometric view of the transmission filter system, which exhibits the L-pin inserted into a hole in the transmission filter that allows for the L-pin to be used to remove or install the transmission filter.

FIG. 8 is an orthographic view of the transmission filter system, which exhibits the alignment of indicator markings on the transmission filter and the stationary component of the transmission filter receiver that signifies that the filter is in position to be changed.

FIG. 9 is an isometric view of the transmission filter system, which exhibits the filter which was rotated 180 degrees by the L-pin.

FIG. 10 is an orthographic view of the transmission filter system, which exhibits that the hollow shaft of the stationary component of the transmission filter receiver is closed off by the mobile component of the transmission filter receiver, when the transmission filter is put into position to be changed.

FIG. 11 is an orthographic view of the transmission filter system, which exhibits that the aperture of the stationary component of the transmission filter receiver is closed off by the mobile component of the transmission filter receiver, when the transmission filter is put into position to be changed.

FIG. 12 is an isometric view of the transmission filter system, which exhibits that the transmission filter is pushed out slightly by the spring inside of the mobile component of the transmission filter receiver, when the transmission filter is put into position to be changed.

FIG. 13 is an orthographic view of the transmission filter system, which exhibits the transmission filter removed from the transmission filter receiver. Note that the hollow shaft of the stationary component of the transmission filter receiver is still obstructed.

FIG. 14 is an orthographic view of the transmission filter system, which exhibits the transmission filter removed from the transmission filter receiver. Note that the aperture of the stationary component of the transmission filter receiver is still obstructed.

FIG. 15 is an isometric view of the transmission filter and the L-pin, which exhibits that the L-pin may be removed after the transmission filter change, which can then be recycled separately.

FIG. 16 is an isometric view of the transmission filter, which exhibits the head and the main body of the transmission filter.

FIG. 17 is an isometric view of the transmission filter, which exhibits the pleated filtration surface and the magnet that are responsible for filtration.

FIG. 18 is an isometric view of the head of the transmission filter, which exhibits the grooves and protrusions that hold the filter in place when installed, indicator markings, and a combination of a hex bolt, a socket wrench depression, and holes for usage of the L-pin to install, remove, change, or hold the filter in place.

FIG. 19 is an orthographic view of the transmission filter, which exhibits a proposed geometry for the filter. The trapezoidal portion represents the body, the indents represent grooves, and the semicircle represents the pleated filtration surface.

FIG. 20 is an orthographic view of the mobile component of the transmission filter receiver, which has an opening of the same geometry of the transmission filter to accommodate for the insertion of the transmission filter. The small protrusions are rails that ensure proper alignment of the transmission filter, and allow for the mobile component of the transmission filter receiver to move along with the transmission filter.

FIG. 21 is an isometric view of the mobile component of the transmission filter receiver, which exhibits the geometry of the mobile component of the transmission filter, that allows for it to simultaneously open or close off the hollow shaft of the stationary component of the transmission filter receiver, when the filter is installed or in the process of being changed. It also exhibits the apertures in the mobile component of the transmission filter receiver, that allow for filtration.

FIG. 22 is an isometric view of the mobile component of the transmission filter receiver, which exhibits the geometry of the mobile component of the transmission filter receiver that allows for it to simultaneously open or close off the apertures of the stationary component of the transmission filter receiver when the filter is installed or in the process of being changed, respectively.

FIG. 23 is an orthographic view of another possible profile of the body of the transmission filter. Other profiles may be used, based off of other shapes, such as octagons, pentagons, et cetera, all using the canister concept of the invention being presented.

FIG. 24 is an orthographic view of another possible geometry of the mobile component of the transmission filter receiver. There are numerous possibilities, depending on the profile of the transmission filter that is chosen.

FIG. 25 is an isometric view of the stationary component of the transmission filter receiver, which exhibits the hollow shaft that connects to the transmission pump intake, and the apertures that allow for filtration when the transmission filter is installed.

FIG. 26 is an isometric view of the stationary component of the transmission filter receiver, which exhibits the portion that the transmission filter engages during installation, the indicator marking that indicates the position of the transmission filter, and a portion that closes off the aperture of the mobile component of the transmission filter receiver when the filter is in a position to be changed.

FIG. 27 is an orthographic view of the L-pin, which exhibits the only tool necessary to change the transmission filter.

### DETAILED DESCRIPTION OF THE INVENTION

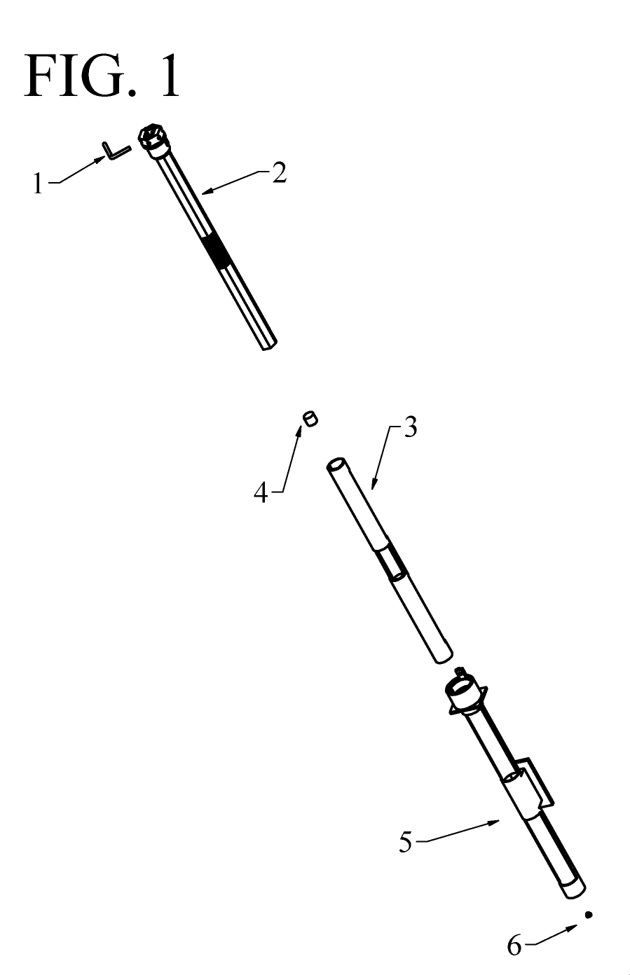

As shown in FIG. 1, the system primarily consists of six main components. Reference character 1 refers to the L-pin, the only tool necessary to change the transmission filter, reference character 2 refers to the transmission filter, reference character 3 refers to the mobile component of the transmission filter receiver, reference character 4 refers to the spring housed in the far end of the mobile component of the transmission filter receiver that aids in ejection of the transmission filter, reference character 5 refers to the stationary component of the transmission filter receiver, and reference character 6 refers to an axle that holds the system together and allows for the mobile component of the transmission filter receiver to move along with the transmission filter. The axel may be a bolt or a rivet.

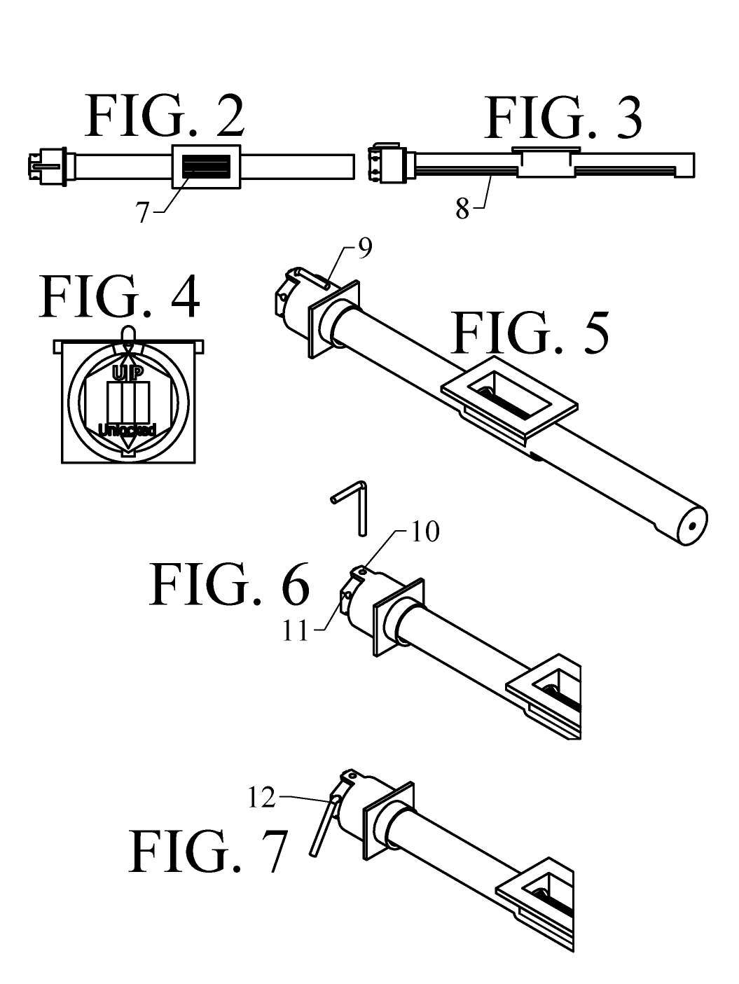

When fully assembled, with the transmission filter installed, the invention proposed is shown in FIG. 2, FIG. 3, FIG. 4, and FIG. 5. Note that in FIG. 2, as indicated by reference character 7, the hollow shaft of the stationary component of the transmission filter receiver that connects to the transmission filter pump is aligned with an aperture in the mobile component of the transmission filter receiver, which allows for the transmission filter pump to withdraw transmission filter, thus resulting in filtration when the transmission filter is installed. As shown in FIG. 3, indicated by reference character 8, the filtration surface of the transmission filter is exposed through the alignment of apertures in the mobile and stationary components of the transmission filter receiver when the filter is installed. There are indicator markings on the stationary component of the transmission filter receiver, and the transmission filter, that indicate whether the transmission filter is properly installed, or in a position to be changed. As shown in FIG. 4, the transmission filter is properly installed. The transmission filter is held in place by a set of protrusions and grooves on the head of the transmission filter, that correspond to another set of protrusions and grooves on the stationary component of the transmission filter receiver. To lock the filter in place, the L-pin used to remove and install the filter may be placed through holes in the stationary component of the transmission filter receiver and the head of the transmission filter, as shown in FIG. 9, and pointed to by reference character 9.

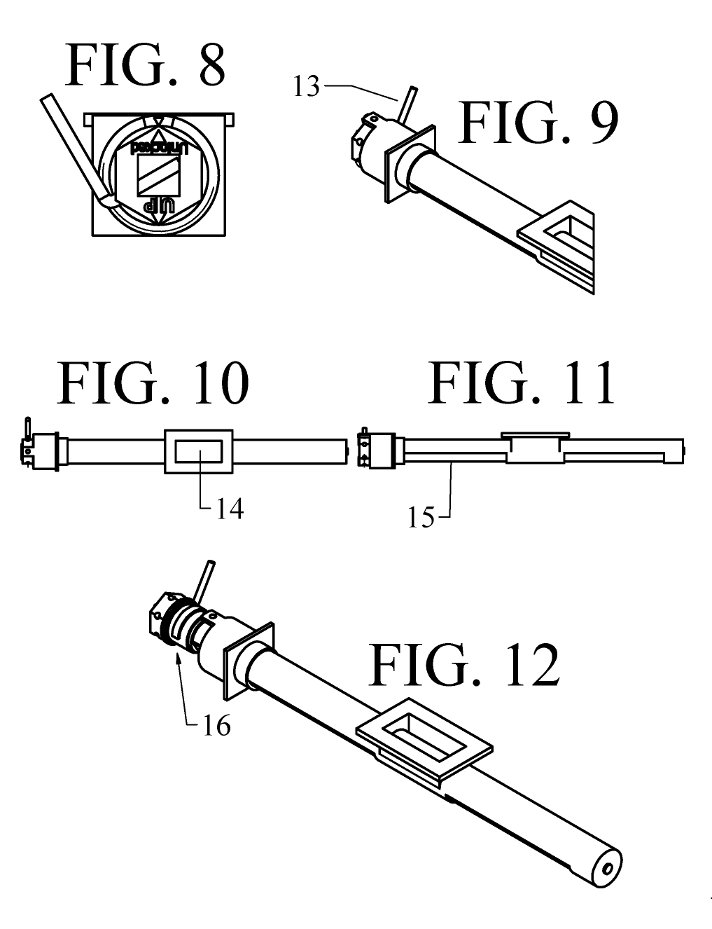

When the transmission filter needs to be changed, the L-pin is removed, as shown in FIG. 10, from the hole indicated by reference character 10, and inserted into a hole on the transmission filter, as indicated by reference character 11. This brings us to the position in FIG. 12, with the L-pin allowing for the application of torque to the transmission filter without any additional tools. Rotation of the filter by 180 degrees places the filter in an unlocked position, to be removed and replaced. As shown in FIG. 8, the indicator signifies that the filter is ready to be changed, and FIG. 9 offers an isometric perspective on the position of the filter. The rotation of the filter into a position to be changed simultaneously applies torque on the mobile component of the transmission filter receiver, which closes off the hollow shaft and apertures of the stationary component of the transmission filter receiver, as shown in FIG. 10 and FIG. 11. Reference character 14 points to a portion of the mobile component of the transmission filter receiver that is now obstructing the hollow shaft of the stationary component of the transmission filter receiver to prevent leakage of fluid into the surroundings and contamination of the transmission pump. Reference character 15 points to a portion of the mobile component of the transmission filter receiver, that closes off the apertures in the stationary component of the transmission filter receiver, which prevents leakage of fluid into the surroundings from the transmission fluid reservoir. Thus, the proposed canister transmission filter system reduces contamination of both the surroundings and the transmission system, during the transmission filter change procedure.

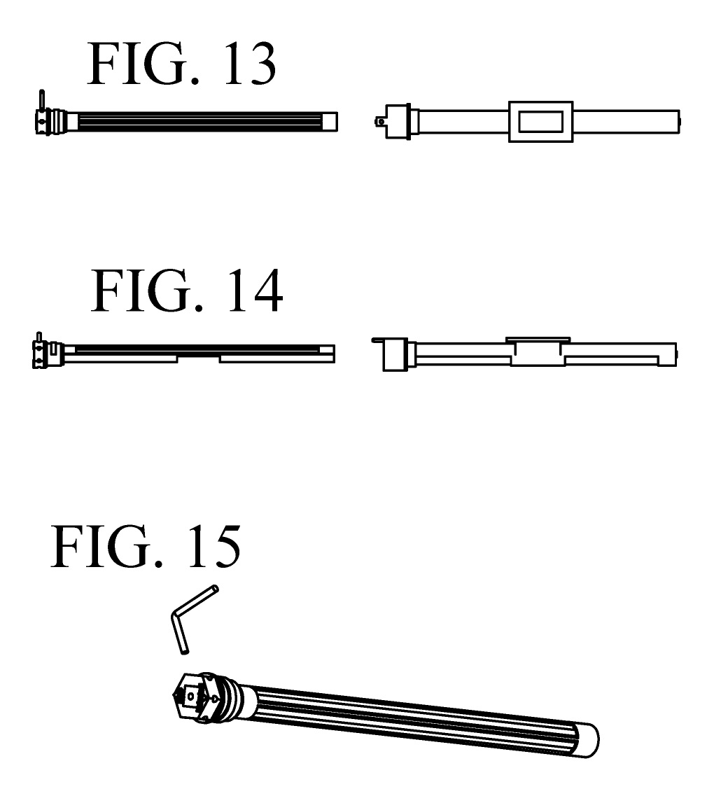

Due to the spring housed inside of the mobile component of the transmission filter receiver, when the filter is in position to be changed, the filter is pushed out slightly to aid in removal, leading us to FIG. 12. As shown in reference character 16, the head of the transmission filter is now exposed, and the filter may be pulled out. When the filter is fully removed, as seen in FIG. 13 and FIG. 14, the hollow shaft and apertures of the stationary component of the transmission filter receiver are still obstructed, to prevent contamination. To replace the filter, a new filter simply has to be inserted, and rotated 180 degrees using the L-pin. Thus, the simple procedure of changing the transmission filter may be summarized as follows: First, remove the L-pin. Then, insert L-pin into hole in the head of the transmission filter. Rotate the filter 180 degrees. Pull out the used filter. Insert the new filter. Use the L-pin to rotate the new filter 180 degrees. Replace the L-pin, to bolt the filter in place. This level of simplification requires ideally less than five minutes, and allows for nearly any car owner to perform the operation by himself, thus saving both time and money.

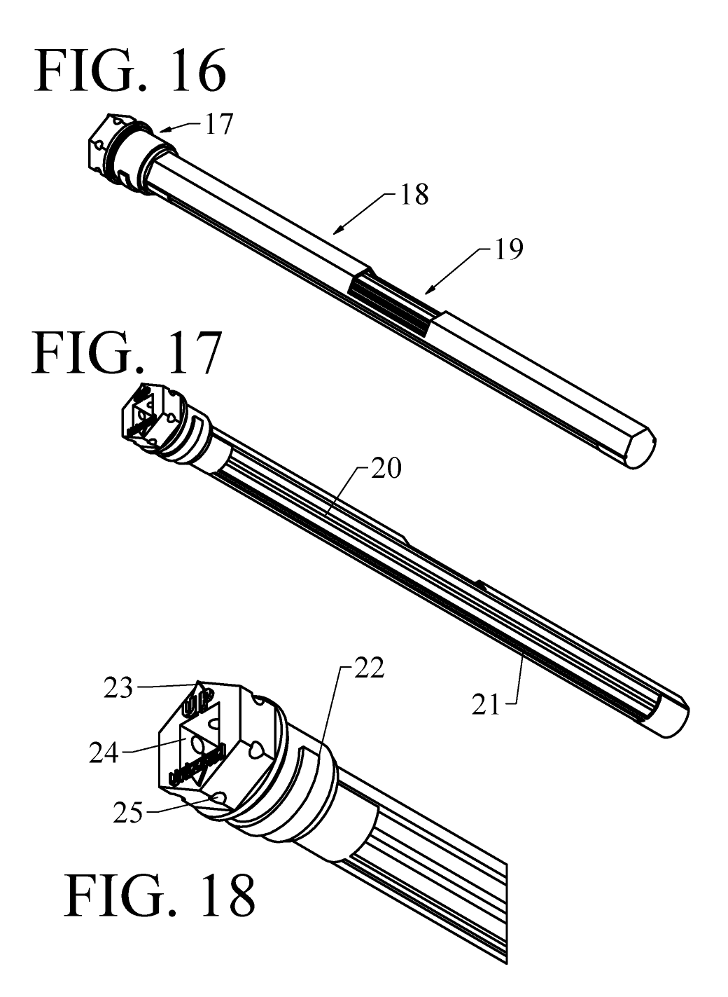

The canister shaped transmission filter is shown in FIG. 16 and FIG. 17. The filter's structure is mainly composed of a head, as referred to by reference character 17, and a canister shaped body, as referred to by reference character 18. The body has an aperture, which aligns with an aperture in the mobile component of the transmission filter receiver and the hollow shaft of the stationary component of the transmission filter receiver, thus connecting to the transmission filter pump that draws transmission fluid through the filter to achieve filtration. As shown in FIG. 17, the filter has a pleated filtration surface, made of metal mesh or fiber, which is referred to by reference character 20. Pleating allows for the proposed filter to have an effective filtration surface area comparable to, or greater than, the prior art standard transmission filter. The pleated filtration surface removes particulate contaminants through physical exclusion. Reference character 21 refers to a magnet that is external of the filtration surface, which greatly enhances filtration efficiency. Metallic particulate matter is especially harmful to the transmission system, as it is sufficiently hard to directly abrade the clutch pads. The magnet removes metallic particulate matter that is too small for the pleated filtration surface to physically exclude, and also metallic particulate matter that is larger, which may clog or cut the pleated filtration surface.

The head of the transmission filter, as shown in FIG. 18, serves a mix of functions. First and foremost, the head has a series of grooves and notches that complement a set of grooves and notches in the stationary transmission filter receiver, to lock the filter in place when the filter is installed. This is pointed to by reference character 22. The same portion allows for the usage of O-rings, in order to ensure that the system is properly sealed. Compared to the prior art transmission filter system, where the seal between the transmission reservoir pan must be removed and replaced every time the filter is changed, the proposed invention has far less of a probability of leakage. Reference character 23 points to the indicator marking on the head of the transmission filter. Although the only tool necessary is the L-pin, if the car owner prefers to use a socket or an adjustable spanner wrench, the head of the transmission filter allows for compatibility with those tools. The head is mainly hexagonal, and thus the adjustable spanner wrench may be directly applied. Reference character 24 indicates a square depression to allow the usage of a socket wrench. The holes, as indicated by reference character 25, allows for the usage of the L-pin to change the filter, and in complement with the stationary component of the transmission filter receiver, allows for the L-pin to be used to secure the transmission filter in place.

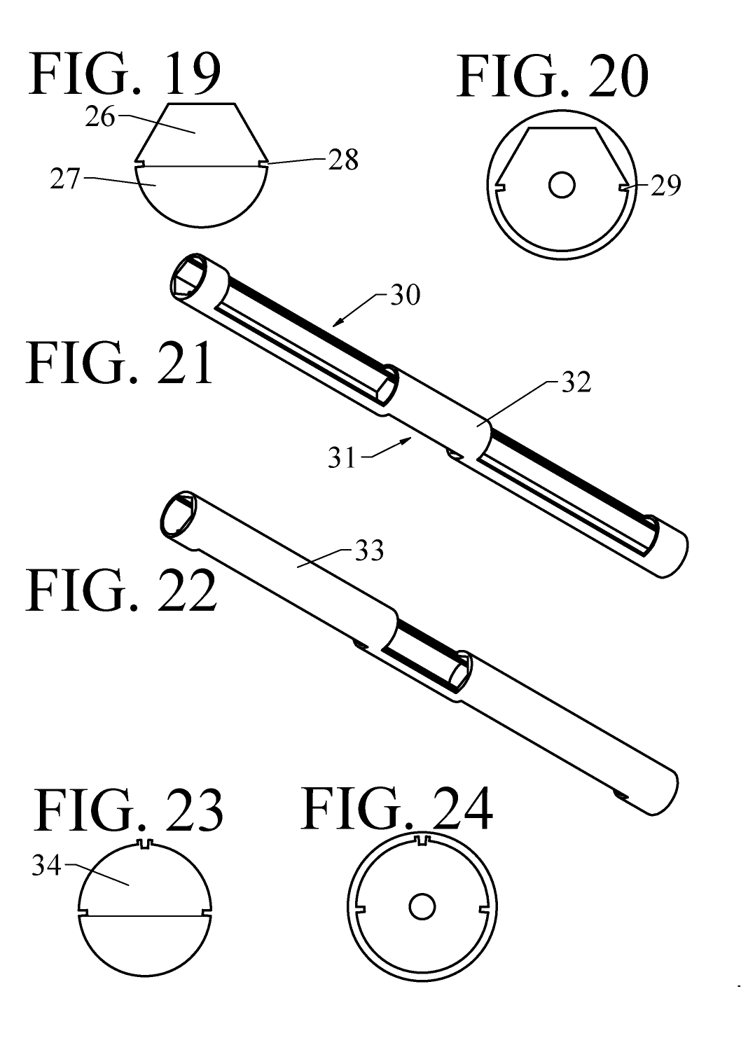

The filter may either be cylindrical, or a polygonal (hexagonal, octahedral, etc.) prism, so as long as the mobile component of the transmission filter receiver is likewise shaped, as to accommodate for it. As shown in FIG. 19, the transmission filter in the majority of the depictions of the proposed invention was based off a right hexagonal prism. Reference character 26 points to the trapezoidal profile of the body of the filter, as half of a regular hexagon is an isosceles trapezoid. Reference character 27 points to the semicircle, which in this case, is used to represent the profile of the filtration surface. However, the pleating is not seen, because the end of the filter body is closed off. The receiver also may be any shape, so as long as it is compatible with the filter, as shown in FIG. 20. Reference character 27 refers to a long indentation along the length of the filter body, which in complement with the protrusion as shown in reference character 29, ensures proper alignment of the transmission filter, and simultaneously moves the mobile component of the transmission filter receiver when the transmission filter is installed or put into a position to be changed. Thus, the features indicated by reference character 28 and reference character 29 are essential to the function of the system, and are responsible for the automatic opening and closure of the hollow shaft and apertures of the stationary component of the transmission filter receiver by the mobile component of the transmission filter receiver when the transmission filter is installed or being changed.

The mobile component of the transmission filter system has a geometry that complements with the stationary component of the transmission filter system, and corresponds to the pleated filtration surface and aperture of the transmission filter. As seen in FIG. 21, the mobile component of the transmission filter receiver has two types of apertures. Reference character 30 refers to apertures that align with the apertures of the stationary component of the transmission filter receiver and the pleated filtration surface of the transmission filter, when the transmission filter is installed. Alignment of the aperture as pointed to by reference character 30 with the aperture of the stationary component of the transmission filter receiver exposes the transmission filter's pleated filtration surface to the inside of the transmission fluid reservoir, thus allowing for filtration. Reference character 31 refers to an aperture that aligns with the aperture on the transmission filter, and connects the filter to the hollow shaft of the stationary component of the transmission filter receiver, thus allowing for the transmission fluid pump to withdraw transmission fluid through the filter when the filter is installed. When the filter is in a position to be changed, the portion of the mobile component of the transmission filter receiver, as indicated by reference character 32 closes off the hollow shaft of the stationary component of the transmission filter receiver, thus preventing leakage and contamination of the surroundings, and protecting the transmission fluid pump intake from contamination by the surroundings. Likewise, the portion of the mobile component of the transmission filter receiver as indicated by reference character 33, closes off the apertures of the stationary component of the transmission filter receiver, thus preventing leakage of transmission fluid into the surroundings from the transmission fluid reservoir.

As shown in FIG. 23, and FIG. 24, there is a variety of geometries that are compatible with the concept of a canister transmission filter system, so as long as the receiver is adjusted to accommodate for the transmission filter. As pointed out by reference character 23, in FIG. 23, the filter is based off a cylinder. FIG. 23 and FIG. 24 originate from earlier designs for the system, but it was concluded that basing the filter off a hexagon would save the most materials, while permitting for ease of manufacturing.

The transmission filter may be made of a combination of plastics, metal, and composites, to cut costs. For example, the body of the filter may be made of plastic, and the head may be made of metal. The prior art filter features a roughly rectangular metal casing that nearly fully encloses the filtration surface. Thus, the proposed filter is more efficient, given the relatively higher cost of steel versus that of plastic, and the greater amount of material necessary to manufacture a rectangular box compared to a cylinder or half of a polygonal prism to achieve a filter with the same effective filtration surface area. Thus, the difference in geometry and composition of the filter reduces customer costs, relative to that of the prior art filtration system.

The canister shape of the transmission filter also cuts costs, as it allows for easier storage and shipping of the transmission filter, without the need of excessive packaging. The prior art transmission filter usually is packaged in a box, with the majority of the volume of the box as empty space. For a container of equal volume, far more units of the proposed transmission filter can be shipped. The proposed filter may additionally be packaged in a plastic sleeve to reduce cost and waste of packaging materials, as the sleeve may be repurposed to contain the used filter, which can then be returned for recycling. Since the amount of material required to make the filter and package the filter is less than that of the prior art, the mass per unit would also be decreased, which reduces manufacturing, shipping, and storage costs. The prior art filter also varies depending on the make and the model of the vehicle at hand. This variety makes it difficult and time consuming for the car owner to obtain a transmission filter that fits their vehicle. This canister system may be easily standardized, so that owners of cars of all makes and models can quickly obtain a filter for their vehicle due to widespread cross compatibility. All these savings add up to decrease the per unit price of the transmission filters, which, in turn, reduces the costs that the car owner has to pay.

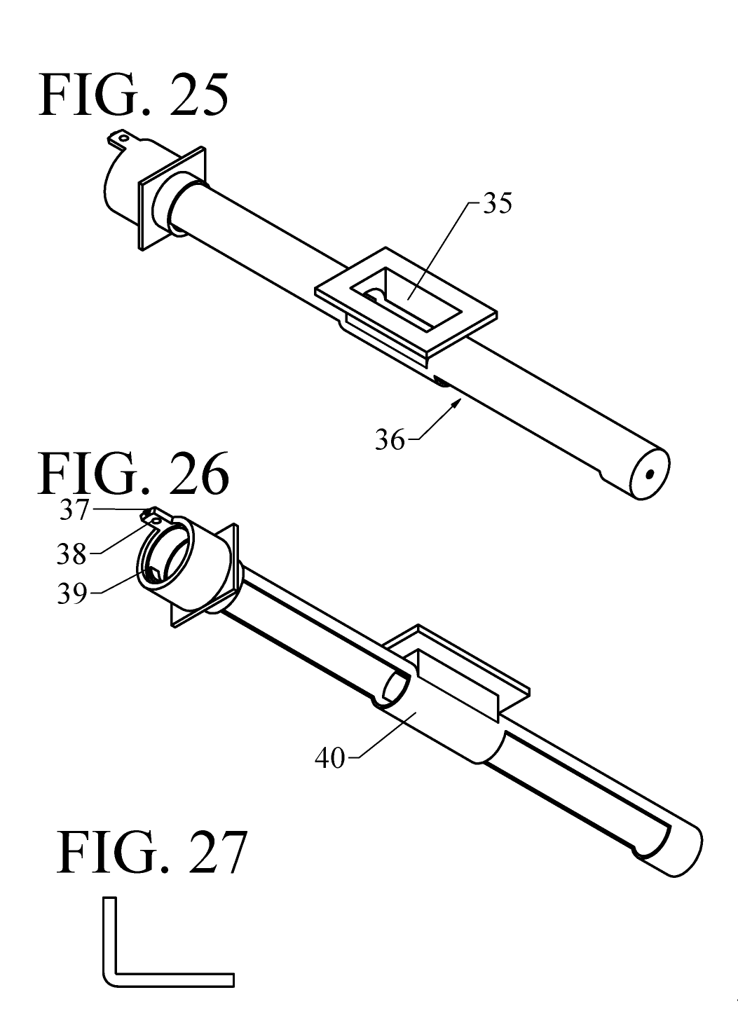

The stationary component of the transmission filter receiver is shown in FIG. 25 and FIG. 26. Although the transmission filtration system may be integrated into the body of the transmission system, it is far easier and cheaper for car manufacturers to integrate the transmission filter receiver into transmission fluid reservoir pans, as it is easier to redesign transmission fluid reservoir pans than transmission systems for a variety of vehicles. Thus, the proposed transmission filtration system connects to the transmission fluid pump through a hollow shaft in the stationary component of the transmission filter receiver, as referred to by reference character 35. A gasket may be employed to ensure proper sealing. However, future cars may also include an additional component attached to the transmission pump intake that directly couples with the system.

Reference character 36 refers to the aperture in the stationary component of the transmission filter receiver that aligns with corresponding apertures in the mobile component of the transmission filter receiver to allow for the exposure of the pleated filtration surface of the transmission filter to the inside of the transmission fluid reservoir, thus allowing for filtration. Both the hollow shaft and the apertures are open when the transmission filter is installed, as they are required to permit transmission fluid flow during normal operation. To prevent leakage into the surroundings and also to protect the transmission fluid pump intake from contamination when the filter is changed, the motion of the transmission filter causes the mobile component of the transmission filter receiver to simultaneously obstruct both the hollow shaft and the apertures. Reference character 40 indicates a portion of the stationary component, that obstructs the corresponding aperture of the mobile component of the transmission filter receiver during transmission filter changes. The aperture that is obstructed by the portion designated reference character 40 is responsible for allowing the transmission fluid pump to withdraw transmission fluid through the transmission filter. When the filter is installed, the mobile component of the transmission filter receiver then returns to the original position of normal operation.

Reference character 37, reference character 28, and reference character 39 all interact with the head of the transmission filter. Reference character 37 refers to the indicator marking of the stationary component of the transmission receiver, which aligns with indicator markings on the transmission filter to indicate whether the filter is installed or in position to be changed. The hole designated reference character 38 is used in conjunction with the L-pin as shown in FIG. 27 to secure the filter in place during installation, and also to hold the L-pin when it is not being used. Note that the hole in the stationary component of the transmission filter receiver corresponds to a hole in the head of the transmission filter when the filter is properly installed. Reference character 39 is a series of grooves and protrusions that engage with the corresponding set of grooves and protrusions on the head of the transmission filter, to secure the filter in place when the filter is installed. Note that in FIG. 27, the L-pin is asymmetrical, to allow for optimization of torque when changing the transmission filter, and also to allow for it to be conveniently stored in a fashion that also secures the transmission filter in place.

In the proposed invention, the mobile and stationary components of the transmission filter receiver are seen to be complementary. The two components, which during normal operation allow for the flow and filtration of transmission fluid, work together to close off the transmission fluid reservoir and transmission fluid pump intake during transmission filter changes. The receiver is preferably made of metal, as it is required to last the entire lifetime of the vehicle. The manufacturing of the transmission filter out of cheaper, softer metal allows for reduction of cost and eliminates the possibility of wear on the transmission filter receiver during transmission filter changes. During transmission filter changes, the sleeve in which the new filter was originally in can be repurposed to bag up the old transmission filter for recycling, thus reducing contamination of the surroundings and wastage of materials.

With the proposed canister transmission filter system, changing the transmission filter costs significantly less time, resources, and money. The simplicity of the procedure allows for nearly any car owner to quickly change the filter, and the standardization of the transmission filters allow car owners to easily obtain a replacement filter that is compatible with their vehicle. The corresponding ease of integration of the filter receiver into the transmission filter pan allows for ease of adoption of the system for vehicle manufacturers. The reduction of amount of necessary manufacturing and packaging materials and the ability to fit more units into a given volume, leads to corresponding reductions in manufacturing, shipping, and storage costs, while simultaneously helping to conserve the environment. The reduction of contamination of the surroundings due to the closure of the receiver allows for quick and easy cleanup. The filter, with a pleated filtration surface and an integrated magnet, is more effective than the prior art standard. The transmission filter ideally costs less than $15, as compared to the prior art filter cost of approximately $25, requires less than ten minutes to change, as compared to the prior art filter change time of half an hour to an hour, and does not require any additional tools, compared to the prior art's need of various tools depending on the car make and model. Thus, given that the car owner can replace the filter by himself instead of hiring an auto mechanic, the car owner can save nearly an hour of wait time, and also more than half of the prior art standard price. All the above factors contribute to the motive of the creation of the art proposed.

The invention claimed is:

1. A canister transmission filter system, consisting of a transmission filter and a transmission filter receiver that the filter is inserted into.

2. The transmission filter receiver according to claim 1, wherein the receiver connects to the transmission pump intake by a hollow shaft, and the receiver has an aperture that exposes the filtration surface of the transmission filter to the transmission fluid reservoir to achieve filtration.

3. The transmission filter system, according to claim 1, wherein the receiver is composed of a complementary set of mobile and stationary components, that closes off transmission fluid flow when the filter is put in a position to be changed, and allows for transmission fluid to flow to achieve filtration when the transmission filter is properly installed.

4. The transmission filter system according to claim 1, wherein the filter can be changed, removed, or installed without any additional tools except for a L-pin that also serves to secure the filter when the filter is properly installed.

5. The transmission filter system according to claim 1, wherein the receiver may be integrated into a transmission reservoir pan, to increase compatibility with preexisting vehicles, or directly integrated into future transmission systems.

6. A transmission filter receiver that opens when the filter is installed to allow for filtration, and closes when the filter is being changed, to prevent both leakage of transmission fluid and contamination of the transmission system and surroundings.

7. The transmission filter receiver according to claim 6, wherein the receiver closes off the transmission fluid pump intake and the transmission fluid reservoir when the transmission filter is being changed, to prevent contamination of the transmission system by particles inside the transmission fluid reservoir and the surroundings, and opens to allow for filtration when the filter is installed.

8. The transmission filter receiver according to claim 6, wherein the receiver has a series of notches and grooves to ensure proper alignment of the filter, and to coordinate movement of the transmission filter receiver with that of the filter.

9. The transmission filter receiver according to claim 6, wherein the receiver has an ejection mechanism that utilizes a spring, to assist with the removal and installation of the filter.

10. The transmission filter receiver according to claim 6, wherein the receiver includes a small marking that indicates whether the receiver is closed or open, and whether the filter is properly installed or in a position to be changed.

11. A canister transmission filter that includes a pleated filtration surface to remove contaminant particles from the fluid.

12. The canister transmission filter according to claim 11, wherein the filter is cylindrical or a polygonal prism, which utilizes a series of notches or grooves to ensure proper alignment.

13. The transmission filter according to claim 11, wherein the filter is screwed to change, remove, or install.

14. The transmission filter according to claim 11, wherein the filter has an indicator marking that shows whether the filter is properly installed.

15. The transmission filter according to claim 11, wherein the filter locks into place due to a set of grooves, protrusions, or threads on the transmission filter body, and can be changed without any additional tools except for a provided L-pin.

16. The transmission filter according to claim 11, wherein the filter body is comprised of a composite of polymer plastic, rubber, and metal to reduce costs, ensure tight sealing, and to reduce wear on components that the filter is in contact with.

17. The transmission filter according to claim 11, wherein the new filter is supplied in a sealable plastic sleeve that is capable of containing the old filter, which may be then recycled.

18. The transmission filter according to claim 11, wherein the filter can have a hex head or depressions that are compatible with common wrenches, such as adjustable spanner or socket wrenches.

19. The transmission filter according to claim 11, wherein the filter includes a magnet to remove metallic particulate matter from the transmission fluid.

20. The transmission filter according to claim 11, wherein the filtration surface is composed of metallic mesh or fiber that allows for physical exclusion of the particulate contaminants.
